(19) United States
(12) Patent Application Publication
(10) Pub. No.: US 2010/0282356 A1
(43) Pub. Date: Nov. 11, 2010

(54) Low emissive radiant barrier flex (LOW-E FLEX)

(75) Inventor: Scott Michael Sawyer, SR., Salisbury, MD (US)

Correspondence Address: US Energy Efficiency Group LLC;c/o Scott M. Sawyer Sr., 3789 Layfield Rd, Salisbury, MD, 21804, US

(73) Assignee: Scott Sawyer, Salisbury, MD (US)

(21) Appl. No.: 12/387,756

(22) Filed: May 7, 2009

(51) Int. Cl. F16L 59/08; F16L 11/00

(52) U.S. Cl. 138/149; 138/137; 428/36.91

(57) ABSTRACT

This specification and the resources and research attach hereto provide the basis for a low cost high efficiency low emissive flex duct for air distribution especially where it pertains to the HVAC trade in buildings. The reflective radiant material used in this invention is already certified by energy star for current applications and increases the energy efficiency of a structure as well as the health of those persons or beings dwelling, residing, or working with in said structure. The manufacturing process is also efficient in that manufacturers of current/preexisting duct can use the same machines and processes with only a change of material.

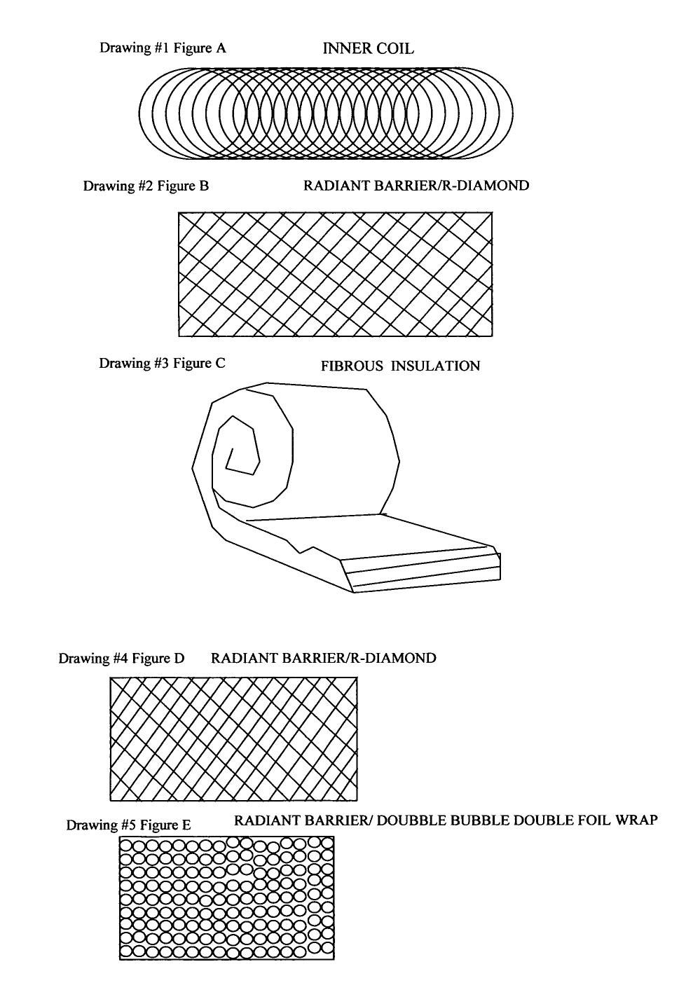

### REFERENCE AND EXISTING PATENTS CITED

### Wikipedia Radiantbarrier.com

Us Patent office Hart & Cooley product information

### We-intl.com Energyefficientsolutions.com

U.S. Patent Documents

| | | |
|---|---|---|
| 910,770 | January 1909 | Armstrong |
| 1,052,861 | February 1913 | Swanson et al. |
| 2,683,466 | July 1954 | Guiles |
| 2,913,011 | November 1959 | Noyes et al. |
| 3,116,759 | January 1964 | Webb |
| 3,300,571 | January 1967 | Downey et al. |
| 3,860,043 | January 1975 | Kutnyak et al. |
| 4,098,298 | July 1978 | Vohrer |
| 4,196,755 | April 1980 | Kutnyak et al. |
| 4,224,463 | September 1980 | Koerber et al. |
| 4,308,895 | January 1982 | Greco |
| 4,599,784 | July 1986 | Canu, Jr. et al. |
| 4,899,787 | February 1990 | Ouchi et al. |

### CONTENT OF ATTACHED REFERENCE SHEETS

### Existing Product Specifications for Reference

| | |
|---|---|
| Current flex duct | REF-F1 |
| Radiant Barrier (double bubble double foil) | REF-F2 |
| Radiant Barrier (r-diamond) | REF-F3 |

None of this research was federally sponsored or developed.
There are no joint parties associated with this application.
There is no Sequence listing as this filing does not involve nucleotides or amino acids.

### BACKGROUND

What is flex? Flexible Ducts, known as “flex”, have a variety of configurations. For the purpose of this invention we will only reflect on the purposes of Heating, Air Conditioning, and Ventilation (HVAC) applications. Flex was created for the purpose of aiding the distribution of air flow to return and supply vents, in areas of a structure where larger rigid duct board is contraindicated by either limited space or obstruction. Flex is typically constructed of plastic over a metal coil to make a round flexible duct for air to pass through (this is the inner core). The duct is then wrapped with a thick layer of fibrous insulation to add “r-value” and then a second layer of plastic, aluminum, or paper is applied to the outer shell to protect the insulation.

Why does it need to be changed? While there are several different types of flex duct currently on the market, the basic problems these products pose both to the installer and consumer are similar, and regrettably have not been improved upon for over a decade. Many who deal with this product on a normal basis, (namely the installers) have become accustomed to the inefficiencies and multitude of drawbacks however they also have no choice. (Examples of current flex duct specifications can be seen by referring to the attached reference pages. Please refer to reference page marked REF-F1.) Some of the more common issues they face are outlined in the paragraphs below.

Heat gain/loss: Terms for the amount of heating (heat loss) or cooling (heat gain) needed to maintain desired temperatures and humidity in controlled air. Regardless of how well-insulated and sealed a building is, buildings gain heat from warm air or sunlight or lose heat to cold air and by radiation. Current flex duct construction allows for radiated heat gain/loss to infiltrate the air flow. Ductwork, especially when contained in the attic, is a big source of energy loss. The reason is that ductwork is typically insulated to much lower R-values than ceilings or walls and faces a much higher temperature difference than a typical indoor-outdoor temperature difference. As a result, when a home is being heated with delivery air of 130° F., the other side of that R-6 insulation might be 15° F.! Under these conditions, consider an example in which ducts in an attic are insulated to R-6 and the ceiling is insulated to R-38. In this case, while the heat is on, the amount of energy being lost from just 20 linear feet of 12-inch ductwork in the attic is greater than the amount of energy lost from over 1000 ft2 of ceiling area!

This has lead to the installers adding additional coefficients in their heat load calculations for determining the size of equipment needed to support heating or cooling of a structure. In many cases this coefficient can lead to oversized equipment causing a serious lack of efficiency. This can contribute to higher heating and cooling costs for the structure. A radiant barrier reflects radiant heat energy instead of trying to absorb it. What does this mean in your home or business? During the winter, 50-75% of heat loss through the ceiling/roofing system and 65-80% of heat loss through walls is radiant. In the summer, up to 93% of heat gain is radiant. If you are depending on R-value (resistance) alone to insulate against heat gain and loss, remember that thin layers of fiberglass are virtually transparent to radiant energy and are affected by changes in humidity (moisture levels). A 1- 1/2% change in the moisture content of fiberglass insulation will result in a 36% decrease in performance (referenced from HVAC Manual 10.6; McGraw-Hill). A pure aluminum radiant barrier is unaffected by humidity and will continue to perform at a consistent level no matter how humid it may be.

Permeability and Penetrability: Measure of the ability of a material to transmit fluids and the ease in which a material can be penetrated. The current materials used to created flex duct are both permeable and penetrable, allowing elements such as humidity, moisture, and allergens into the closed air system. Unfortunately this also allows other undesirables, such as rodents to intrude. The ease in which the plastic or paper outer core is penetrated makes them easily accessed by mice, and other pests. It also is a hassle to installers who must handle the product with care as to not tear a hole in the outer or inner coils during install, should a tear occur the product must be re-cut. This causes not only a time loss but also a waste in product. The permeability of the weak plastic and/or paper allows the moisture in the air (be it humidity or condensation) to be absorbed by the fibrous insulation creating a breading ground for molds, mildews and fungus. This brings us to the problems arising from the fibrous insulation itself.

Fibrous insulation: materials which retard the flow of heat energy. Fibrous insulation is composed of small diameter fibers which finely divide the air space. The fibers may be perpendicular or horizontal to the surface being insulated, and they may or may not be bonded together. Silica, rock wool, slag wool and alumina silica fibers are used. The most widely used insulations of this type are glass fiber and mineral wool. The insulation is in many ways an irritant. The fibers can cause itchy rashes if skin is in direct contact for long periods of time. The fibers, if released into the air can cause adverse reactions to those suffering from asthma, COPD, emphysema, or other breathing conditions, and in some cases even an allergic reaction. It acts as a wick to moisture. It is a fire hazard if not installed correctly, and provides an ideal nesting ground for pests. With the advancements made in new insulating technologies, these insufficiencies should have been significantly reduced, if not erased before now.

### BRIEF SUMMARY

What is radiant barrier? Radiant barriers or reflective barriers work by reducing heat transfer by thermal radiation. They are highly reflective, low emittance materials currently energy star approved for decreasing the heat loss/gain of structures when applied to the attic and/or roof. The two most common types of radiant barriers used are radiant double bubble double foil and r-diamond.

What Benefit would radiant technology add to flex duct? With research, it has been proven that wrapping ductwork with a radiant barrier significantly lowers the heat loss/gain, and adds a layer of less permeable and less penetrable material to the outer coil. This has been proven to add efficiency the operating HVAC system, and lower heating/cooling costs. For the purpose of this invention we will be focusing on the specifications of NON-perforated radiant barrier. The non-perforated forms are impervious to moisture with a water vapor performance of less than 0.02 perms, a puncture resistance up to 115 psi, and a class1/class a fire rating. These qualities greatly out perform the materials currently used in flex duct, by reducing the ability of mold, mildews, and bacteria to develop, being rodent resistant, and harder to tear. Furthermore; the ability to reflect radiant heat gain/loss would significantly reduce the amount of fibrous insulation needed to maintain r-value standards, or give the option of using the same amount of insulation and increasing the “r-value’. See FIG. F8 for example of radiant heat test on radiant barrier.

Low-E Flex combines the purpose and flexibility of current flex duct, with the benefits of integrating radiant barrier technology.

### DESCRIPTION OF DRAWINGS

Drawing #1 FIG. A: Traditional metal/plastic coil

Drawing #2 FIG. B: Sheet of Radiant Barrier (R-Diamond)

Drawing #3 FIG. C: Fibrous Insulation

Drawing #4 FIG. D: Sheet of Radiant Barrier (R-Diamond)

Drawing #5 FIG. E: Sheet of Radiant Barrier (Double Bubble Double Foil Wrap)

### DETAILED DESCRIPTION OF INVENTION

Energy efficient Low Emissive Flex is flexible duct made with a radiant barrier inner core to reduce amount of fibrous insulation and/or decrease the heat gain/loss associated with air distribution through flex.

The inner core is comprised of an alumifoil, radiant, metallic sheet around the traditional metal coil to form a radiant barrier lined duct for air distribution.

(Manufacture) When referring to drawings Drawing #1 FIG. A wrapped with Drawing #2 FIG. B to form a flexible tube known as the inner coil.

The inner coil is then wrapped with a thin layer of fibrous insulation, r-value and thickness would be determined by desired over all r-value requested, or desired.

(Manufacture) Using Duct/Tube inner coil from above, refer to Drawings. Encapsulate, (or wrap) inner coil with Drawing #3 FIG. C leaving the two ends open (keeping it a tube shape). R-value is usually determines by the thickness of this layer. (Please refer to research and reference page marked REF-F4 for further information on the uses, and testing of each component as well as the thickness and types of insulation required making the desired “r-value”.) For the purposes of basic design properties we will say one (1) inch thick from the inner coil to the outside edge of fibrous insulation.

Then an outer layer of an alumifoil, radiant, metallic barrier will be wrapped around to protect the insulation

(Manufacture) Referring to the Drawings again the fibrous covered tube the outer layer can be accomplished by wrapping either Drawing #4 FIG. D, or, Drawing #5 FIG. E, around the tube as a protective layer for both moisture, radiant heat gain/loss, against rodents, and to keep in the fibrous insulation in order to avoid topical (or skin), eye, nose, or throat irritations thus negating the negative effect to those with respiratory conditions.

1) I claim the addition of certified radiant barrier, or any metallic or alumifoil comparable thereto, to the inner and/or outer core of flex duct work when used for the purpose of higher efficient air distribution.

2) I claim the additions in claim 1) will increase relative r-value and/or decrease amount of fibrous insulation to maintain same r-value.

3) I claim the duct with certified radiant barrier, or any metallic or alumifoil comparable thereto, to the inner and/or outer core of flex duct work when used for the purpose of higher efficient air distribution and achieving higher “r” values with same thickness of insulation or decreasing the thickness of insulative material while still achieving same current listed “r” values
